(19) United States
(12) Patent Application Publication
(10) Pub. No.: US 2025/0315310 A1
(43) Pub. Date: Oct. 9, 2025

(54) METHOD, DEVICE, AND PRODUCT FOR ADJUSTING QUALITY OF SERVICE OF STORAGE VOLUME SET

(71) Applicant: Dell Products L.P., Round Rock, TX (US)

(72) Inventors: Jie Huang, Chengdu (CN); Xingxin Li, Chengdu (CN); Yunyun Duan, Chengdu (CN)

(21) Appl. No.: 18/912,797

(22) Filed: Oct. 11, 2024

(30) Foreign Application Priority Data
Apr. 3, 2024 (CN) 202410404194.5

(51) Int. Cl. G06F 9/50

(52) U.S. Cl. CPC G06F 9/5044; G06F 9/5016; G06F 9/5033

(57) ABSTRACT

Techniques are directed to adjusting the quality of service (QoS) of a storage volume set. Such techniques involve acquiring the performance of each volume in the storage volume set. Such techniques further involve determining a usage rate of a QoS upper limit allocated to a corresponding volume according to each performance. Such techniques further involve reallocating, in response to the usage rate of the QoS upper limit allocated to a first volume in the storage volume set being greater than a first threshold and the usage rate of the QoS upper limit allocated to a second volume in the volume set being less than a second threshold, a part of QoS upper limit in the QoS upper limit allocated to the second volume to the first volume. Accordingly, the overall service capability of the storage volume set can be improved, and service requirements of complex businesses can be met.

### CROSS-REFERENCE TO RELATED APPLICATION

This application claims priority to Chinese Patent Application No. CN202410404194.5, on file at the China National Intellectual Property Administration (CNIPA), having a filing date of Apr. 3, 2024, and having “METHOD, ELETRICAL DEVICE AND COMPUTER PROGRAM PRODUCT FOR ADJUSTING SERVICE QUALITY OF A SET OF STORAGE VOLUMES” as a title, the contents and teachings of which are herein incorporated by reference in their entirety.

### TECHNICAL FIELD

The present disclosure relates to the field of computers, and more specifically, to a method, a device, and a computer program product for adjusting the quality of service (QoS) of a storage volume set.

### BACKGROUND

With the rapid development of information technologies, the demand for data storage continues to grow, posing higher requirements for the performance, reliability, and security of storage systems. Therefore, how to provide high-quality services under limited storage resources has become an important issue. This has given rise to the emergence of the Quality of Service (QoS) technology, which aims to ensure, through a series of technological means, that a storage system can provide stable and reliable services in various situations.

In a storage system, the QoS technology mainly focuses on how to allocate reasonable resources to storage volumes based on different business requirements to ensure their performance. For example, for critical businesses with high latency requirements, more resources need to be allocated to ensure their normal operation.

### SUMMARY OF THE INVENTION

Embodiments of the present disclosure propose a method, a device, and a computer program product for adjusting the quality of service (QoS) of a storage volume set. In a first aspect of the embodiments of the present disclosure, a method for adjusting the QoS of a storage volume set is provided. The method includes acquiring the performance of each storage volume in the storage volume set; determining a usage rate of the QoS upper limit allocated to a corresponding storage volume according to each performance; and reallocating, in response to the usage rate of the QoS upper limit allocated to a first storage volume in the storage volume set being greater than a first threshold and the usage rate of the QoS upper limit allocated to a second storage volume in the storage volume set being less than a second threshold, a part of QoS upper limit in the QoS upper limit allocated to the second storage volume to the first storage volume.

In a second aspect of the embodiments of the present disclosure, an electronic device is provided. The electronic device includes one or a plurality of processors; and a storage apparatus for storing one or a plurality of programs, wherein the one or a plurality of programs, when executed by the one or a plurality of processors, cause the one or a plurality of processors to implement a method for adjusting the QoS of a storage volume set, and the method includes acquiring the performance of each storage volume in the storage volume set; determining a usage rate of the QoS upper limit allocated to a corresponding storage volume according to each performance; and reallocating, in response to the usage rate of the QoS upper limit allocated to a first storage volume in the storage volume set being greater than a first threshold and the usage rate of the QoS upper limit allocated to a second storage volume in the storage volume set being less than a second threshold, a part of QoS upper limit in the QoS upper limit allocated to the second storage volume to the first storage volume.

In a third aspect of the embodiments of the present disclosure, a computer program product is provided, the computer program product being tangibly stored on a non-volatile computer-readable medium and including machine-executable instructions, wherein the machine-executable instructions, when executed, cause a machine to perform the following actions: acquiring the performance of each storage volume in a storage volume set; determining a usage rate of the QoS upper limit allocated to a corresponding storage volume according to each performance; and reallocating, in response to the usage rate of the QoS upper limit allocated to a first storage volume in the storage volume set being greater than a first threshold and the usage rate of the QoS upper limit allocated to a second storage volume in the storage volume set being less than a second threshold, a part of QoS upper limit in the QoS upper limit allocated to the second storage volume to the first storage volume.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which

FIG. 1 is a schematic diagram of an example environment in which embodiments of the present disclosure can be implemented;

FIG. 2 is a flow chart of a method for adjusting the QoS of a storage volume set according to some embodiments of the present disclosure;

FIG. 3 is a process diagram of reallocating a QoS upper limit according to an embodiment of the present disclosure;

FIG. 4A is a diagram of the change process of a first storage volume according to an embodiment of the present disclosure;

FIG. 4B is a diagram of the change process of another first storage volume according to an embodiment of the present disclosure;

FIG. 5A is a schematic diagram of performing adjustment according to a third threshold according to an embodiment of the present disclosure;

FIG. 5B is a schematic diagram of performing adjustment according to a third threshold according to another embodiment of the present disclosure;

FIG. 6 is a schematic diagram of adjusting the QoS of a storage volume set according to an embodiment of the present disclosure;

FIG. 7A to FIG. 7C are schematic diagrams of the effect of a method for adjusting the QoS of a storage volume set according to an embodiment of the present disclosure; and

FIG. 8 is a block diagram of a device that can implement a plurality of embodiments of the present disclosure.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

Managing storage volumes aims to ensure that a storage system can provide stable, efficient, and reliable data storage services when facing different application and business requirements. In order to fully utilize storage resources of the storage volumes, some related technologies only consider how to reasonably set predetermined QoS upper limits of various storage volumes, so that they can meet business requirements during operation. This puts high demands on the predictive ability of management personnel. Regardless of the method used, in related technologies, one storage volume is allocated one QoS upper limit, and various storage volumes only provide storage services according to their allocated QoS upper limits. In addition, a storage volume provider typically sets a QoS upper limit of each storage volume averagely, and therefore, the QoS upper limit of a single storage volume may not be too high. Due to the fact that businesses or applications are typically serviced by specific storage volumes during operation, some businesses or applications that require high service capabilities cannot run on these storage volumes.

The inventor of the present application has researched and found that one reason why it is not possible to improve the service capability of a storage volume set is that the relevant solutions consider that QoS upper limits of various storage volumes are immutable by default. On this basis, the inventor further realizes that the service capability of the entire storage volume set can be improved by dynamically and intelligently adjusting the QoS upper limits of the storage volumes during operation of the storage volumes, and the QoS upper limit of a single storage volume can be temporarily increased for a single complex business or application.

Therefore, the present disclosure proposes a method for adjusting the QoS of a storage volume set. In the embodiments of the present disclosure, in a case where each storage volume is allocated a predetermined QoS upper limit, the performance of each storage volume in a storage volume set is acquired, and a usage rate of the QoS upper limit allocated to a corresponding storage volume is determined according to each performance, thereby obtaining a real-time busy degree of each storage volume. After acquiring the information, by comparing the usage rate of the QoS upper limit of a first storage volume with the magnitude of a first threshold, as well as comparing the usage rate of the QoS upper limit of a second storage volume with the magnitude of a second threshold, it can be known that the first storage volume has an excessive load and the second storage volume has a small load. By reallocating a part of QoS upper limit in the QoS upper limit allocated to the second storage volume to the first storage volume, dynamic and intelligent adjustment of the QoS upper limits between a busy storage volume and an idle storage volume is achieved, thereby improving the overall service capability of the storage volume set. In addition, businesses or applications are usually serviced by specific storage volumes during operation, and the storage volumes that provide services may not be temporarily changed; therefore, in a case that the QoS upper limit of a single storage volume is not high enough, the method of adjusting the QoS of a storage volume set proposed in the present disclosure can dynamically and intelligently reallocate the QoS upper limits of the storage volumes, so that specific storage volumes temporarily have high service capabilities, thereby supporting the operation of businesses or applications with high requirements for service capabilities.

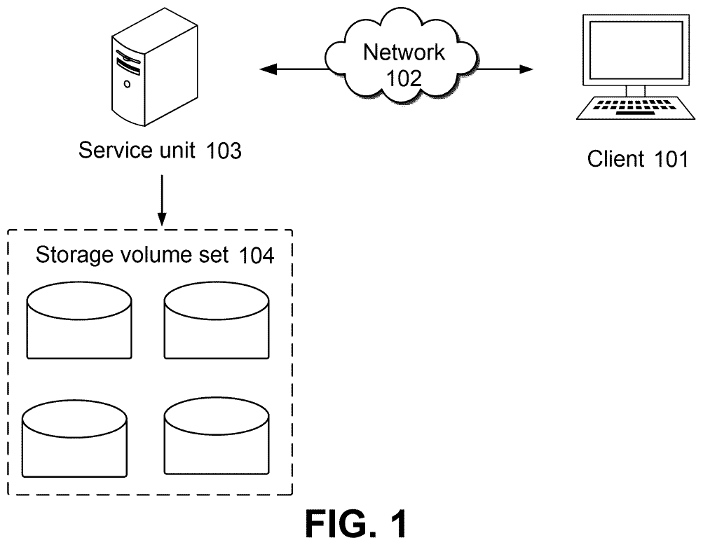

FIG. 1 is a schematic diagram of an example environment 100 in which embodiments of the present disclosure can be implemented. As shown in FIG. 1, the environment 100 may include a client 101, a network 102, and a service unit 103, and the service unit 103 is communicatively coupled to the client 101 through the network 102. The network 102 may be, for example, a Wide Area Network (WAN), a Local Area Network (LAN), a wireless network, a public telephone network, an intranet, and any other type of network well known to those skilled in the art.

In the embodiment, the method of adjusting the QoS of a storage volume set is performed by the service unit 103. The service unit 103 is provided with a storage volume set 104, the storage volume set 104 includes at least two storage volumes, each storage volume is allocated a predetermined QoS upper limit, and one storage volume in the storage volume set 104 provides a service to the client 101. As an example, a storage volume provides a storage service involving input and output operations to the client 101. The client 101 may be considered as a terminal running a specific business or application.

The storage volume in the present disclosure refers to a logical container or logical partition used in a computer system to store and manage data, also referred to as a logical storage volume. Different from actual partitions on a physical storage device (such as a hard drive and a solid-state drive), the logical storage volume is an abstraction layer that provides a unified and easily managed data storage space for an operating system and applications. The logical storage volume provides a virtualized storage layer, so that the operating system and applications or businesses do not need to care about the specific details of underlying physical storage devices. This helps simplify data management and access processes, while improving the system flexibility and scalability. It is built on a physical storage device and provides an abstraction layer to flexibly manage the storage space.

Logical volumes have various advantages, such as dynamic online expansion, offline cropping, data striping, and data mirroring. The size and quantity of logical volumes may be freely configured for more flexible data management. Physical storage volumes, on the other hand, focus more on actual storage of data. They typically refer to disk partitions or disk drives in an operating system, which are underlying devices that truly provide capacity and store data. The physical storage volumes become part of the storage system through standard physical partitioning, thereby providing a physical disk partitioning function for the operating system and providing a certain amount of space for a file system. In addition, the physical storage volumes further involve actual writing and reading of data, which is closely related to hardware. In order to improve data access speed, a series of performance optimizations are usually performed, such as data partitioning, indexing, and caching.

In the embodiment, the method performed by the service unit 103 includes the following steps.

The service unit 103 acquires the performance of each storage volume in the storage volume set 104. For example, the service unit 103 may be provided with a monitoring tool to monitor performance data related to the storage volumes, such as data characterizing the Input/Output Operations Per Second (IOPS) or the bandwidth.

The service unit 103 determines a usage rate of the QoS upper limit allocated to a corresponding storage volume according to each performance. Because each storage volume is pre-allocated a QoS upper limit, and the QoS upper limit may be an upper limit of the IOPS or an upper limit of the bandwidth. The process of allocating a QoS upper limit to each storage volume is performed in advance.

The service unit 103 reallocates, in response to that the usage rate of the QoS upper limit allocated to a first storage volume in the storage volume set 104 is greater than a first threshold and the usage rate of the QoS upper limit allocated to a second storage volume in the storage volume set 104 is less than a second threshold, a part of QoS upper limit in the QoS upper limit allocated to the second storage volume to the first storage volume. In the embodiment, the second storage volume is a storage volume that provides services for applications on the client 101. The usage rates of the QoS upper limits of the storage volumes cannot be predicted, and therefore, dynamic and intelligent adjustment of the QoS upper limits between storage volumes may be achieved based on real-time calculation of usage rates. After the adjustment, the QoS upper limit of the second storage volume is raised, and the corresponding applications on the client 101 may read and store data on the second storage volume at a faster speed.

As shown in FIG. 1, in the environment 100, the network 102 may be used to transmit data between the client 101 and the service unit 103. The network 102 has a theoretical bandwidth. The theoretical bandwidth refers to a maximum transmission speed supported by the network 102, which indicates a maximum data amount that may be transmitted by the network 102 in an ideal condition, typically measured by the number of transmitted bits per second (bps). For example, if the theoretical bandwidth of the network 102 is 100 Mbps, it indicates that it may transmit 100 megabits of data per second in an ideal condition. In fact, however, due to other possible factors in the network (such as signal interference, bandwidth sharing, and transmission delay), the actual transmission speed may not reach 100 Mbps.

As understood by those skilled in the art, an example of the service unit 103 may be a stand-alone physical server, a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The server may be connected directly or indirectly through wired or wireless communication, which is not limited in the present application.

The client 101 may be any type of mobile computing device, including a mobile computer (such as a personal digital assistant (PDA), a laptop, a tablet, and a netbook), a mobile phone (such as a cellular phone and a smartphone), a wearable computing device (such as a smartwatch, and a head-mounted device including smart glasses and the like), or other types of mobile devices. In some embodiments, the client 101 may also be a fixed computing device, such as a desktop computer, a game machine, and a smart TV.

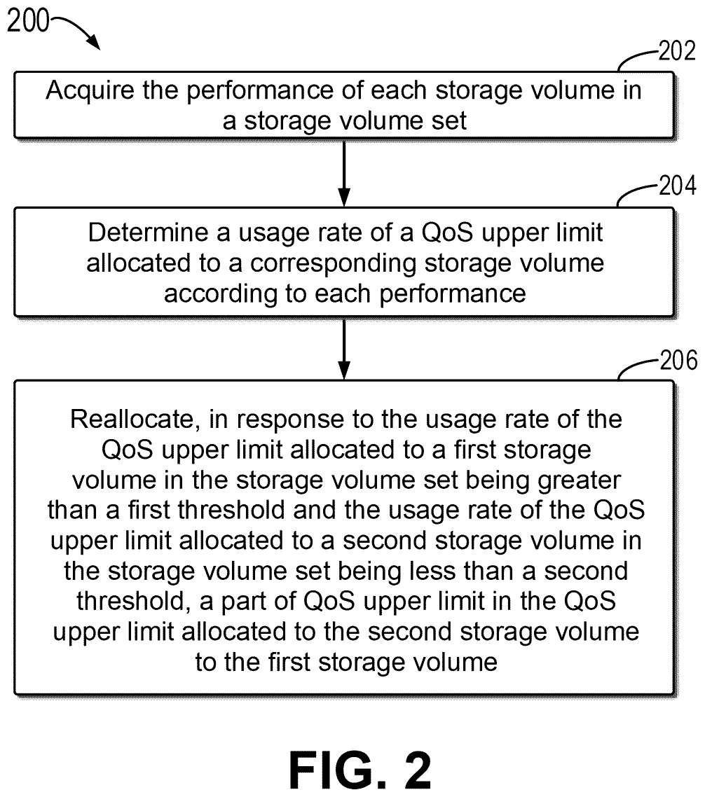

FIG. 2 is a flow chart of a method for adjusting the QoS of a storage volume set according to some embodiments of the present disclosure. As shown in FIG. 2, the flow chart 200 includes a block 202 to a block 206. At the block 202, the performance of each storage volume in a storage volume set is acquired. The storage volume refers to the logical storage volume mentioned above. The performance of a storage volume may be reflected in data that characterizes the performance of the storage volume. In some embodiments, IOPS data of a storage volume may be used to characterize the performance of the storage volume. Alternatively or additionally, the bandwidth of a storage volume may be used to characterize the performance of the storage volume. When data that characterizes performance is acquired, commands such as iostat, vmstat, and sar may be used to monitor the I/O performance of the storage volume. For an operating system being a Windows system, a Performance Monitor may be used to view performance counters of storage volumes, including IOPS. In some alternative embodiments, a third-party monitoring tool may be used and may be integrated into a storage volume system for collecting and analyzing performance data, such as monitoring every 10 or 30 minutes. These tools can provide rich charts and alarm functions.

At the block 204, a usage rate of the QoS upper limit allocated to a corresponding storage volume is determined according to each performance. The QoS upper limit is a performance upper limit set in advance for each storage volume and used for limiting the maximum performance of the storage volume. For example, when IOPS data is used to characterize performance, the QoS upper limit of the corresponding storage volume is an IOPS upper limit of the storage volume.

Similarly, when bandwidth data is used to characterize performance, the QoS upper limit of the corresponding storage volume is a bandwidth upper limit of the storage volume. Other performance characterization data may also be used, which is not limited in the present disclosure. The usage rate reflects a proportional relationship between the current performance of the storage volume and the QoS upper limit, and may be used to evaluate the load situation of the storage volume. When the usage rate is calculated, a formula (1) may be used to divide the real-time IOPS by the allocated IOPS upper limit to obtain the usage rate.

$${r}_{used \_ qos \_ ratio}^{ij} = \frac{{IOPS}_{ij}}{{QoS}_{ij}} \qquad Formula ( 1 )$$

wherein i represents the i-th storage volume in the storage volume set, j represents the moment, r_{used_qos_ratio}^{ij} represents the usage rate of the QoS upper limit of the i-th storage volume at the j-th moment, QoSᵢⱼ represents the old QoS upper limit of the i-th storage volume at the j-th moment, and IOPSᵢⱼ represents the IOPS value of the i-th storage volume at the j-th moment.

At the block 206, the present disclosure may check whether a specific condition is met, namely whether the usage rate of the QoS upper limit allocated to the first storage volume in the storage volume set is greater than a first threshold, and whether the usage rate of the QoS upper limit allocated to the second storage volume is less than a second threshold. These thresholds may be set according to actual application requirements to trigger the reallocation of QoS. If the above condition is met, that is, the load on the first storage volume is too high and the load on the second storage volume is too low, a part of QoS upper limit will be reallocated to the first storage volume from the QoS upper limit allocated to the second storage volume.

According to a method for adjusting the QoS of a storage volume set proposed in the present disclosure, in a case where each storage volume is allocated a predetermined QoS upper limit, the performance of each storage volume in a storage volume set is acquired, and a usage rate of the QoS upper limit allocated to the corresponding storage volume is determined according to each performance, thereby obtaining a real-time busy degree of each storage volume. After acquiring the information, by comparing the usage rate of the QoS upper limit of a first storage volume with the magnitude of a first threshold, as well as comparing the usage rate of the QoS upper limit of a second storage volume with the magnitude of a second threshold, it can be known that the first storage volume has an excessive load and the second storage volume has a small load. By reallocating a part of QoS upper limit in the QoS upper limit allocated to the second storage volume to the first storage volume, dynamic and intelligent adjustment of the QoS upper limits between a busy storage volume and an idle storage volume is achieved, thereby improving the overall service capability of the storage volume set. In addition, businesses or applications are usually serviced by specific storage volumes during operation, and the storage volumes that provide services may not be temporarily changed; therefore, in a case that the QoS upper limit of a single storage volume is not high enough, the method of adjusting the QoS of a storage volume set proposed in the present disclosure can dynamically and intelligently reallocate the QoS upper limits of the storage volumes, so that specific storage volumes temporarily have high service capabilities, thereby supporting the operation of businesses or applications with high requirements for service capabilities.

There are two approaches to reallocating the QoS upper limit. In some embodiments, the second storage volume may have a preset lending upper limit to limit the maximum value of the QoS upper limit reallocated each time. During reallocation, the QoS upper limit allocated to the second storage volume is reduced by the preset lending upper limit to obtain an updated QoS upper limit allocated to the second storage volume. Further, the QoS upper limit allocated to the first storage volume is increased by the preset lending upper limit.

In an embodiment where IOPS data characterizes the performance, reallocation may be completed according to the following formulas (2) and (3).

$$Formula ( 2 )$$

$${QoS}_{ij}^{′} = \{ \begin{matrix}{QoS}_{ij} & If {IOPS}_{ij} < {QoS}_{ij} and ∀ {IOPS}_{kj} < {QoS}_{kj} \\ {QoS}_{ij} - \sum Δ {QoS}_{ij} & If {IOPS}_{ij} < {QoS}_{ij} and ∃ {IOPS}_{kj} > {QoS}_{kj}\end{matrix}$$

wherein i represents the i-th storage volume in the storage volume set, k represents the k-th storage volume in the storage volume set, i is different from k, j represents the moment, QoSᵢⱼ represents the old QoS upper limit of the i-th storage volume at the j-th moment, QoSₖⱼ represents the old QoS upper limit of the k-th storage volume at the j-th moment, QoSᵢⱼ′ represents the new QoS upper limit of the i-th storage volume at the j-th moment, ΣΔQoSᵢⱼ represents the sum of the QoS upper limits lent out by the i-th storage volume at the j-th moment, IOPSᵢⱼ represents the IOPS value of the i-th storage volume at the j-th moment, and IOPSₖⱼ represents the IOPS value of the k-th storage volume at the j-th moment.

$${QoS}_{ij}^{′} = {QoS}_{ij} + Δ {QoS}_{ij} \qquad Formula ( 3 )$$

wherein QoSᵢⱼ represents the old QoS upper limit of the i-th storage volume at the j-th moment, QoSᵢⱼ′ represents the new QoS upper limit of the i-th storage volume at the j-th moment, and ΔQoSᵢⱼ represents the QoS upper limit borrowed by the i-th storage volume at the j-th moment.

This can ensure an orderly and controllable reallocation process. After reallocation, the first storage volume may provide a service to a complex application and therefore be in a busy state. The first storage volume with a higher QoS upper limit may meet requirements of the complex application. In addition, since each reallocation is preset to a fixed value, this can avoid real-time calculation of the QoS upper limit of reallocation and reduce the consumption of computing resources.

In the embodiment, the reallocation is completed according to the lending upper limit of the second storage volume. In another embodiment, the reallocation may be completed according to a borrowing upper limit of the first storage volume. During reallocation, the QoS upper limit allocated to the second storage volume is reduced by the preset borrowing upper limit to obtain an updated QoS upper limit allocated to the second storage volume. Further, the QoS upper limit allocated to the first storage volume is increased by the preset borrowing upper limit. This can also ensure an orderly and controllable reallocation process with similar other effects.

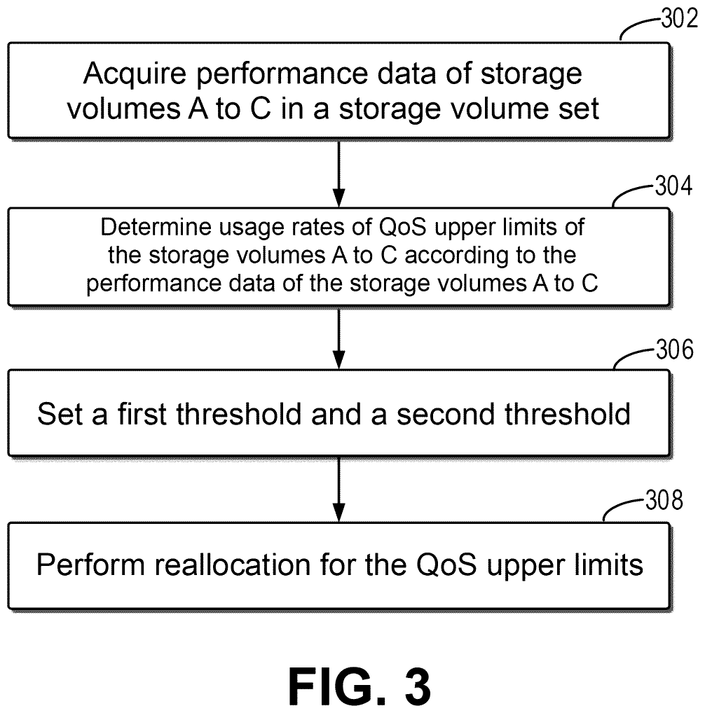

FIG. 3 is a process diagram of reallocating a QoS upper limit according to an embodiment of the present disclosure. In the embodiment shown in FIG. 3, it is assumed that the storage volume set includes a storage volume A, a storage volume B, and a storage volume C. Each storage volume is initially allocated a predetermined QoS upper limit, such as an IOPS (Input/Output Operations Per Second) upper limit. For example, the IOPS upper limit of the storage volume A is 1000, the IOPS upper limit of the storage volume B is 1500, and the IOPS upper limit of the storage volume C is 2000.

At a block 302, performance data for the storage volumes A to C in the storage volume set is acquired. This can be achieved through a monitoring tool, such as regularly collecting current IOPS data for each storage volume. At a block 304, usage rates of the QoS upper limits allocated to the storage volumes A to C are determined based on the performance data of the storage volumes A to C. For example, at a certain moment, the current IOPS of the storage volume A is 800, then the usage rate of its IOPS upper limit is 80% (800/1000). Similarly, the usage rates of the IOPS upper limits of the storage volume B and the storage volume C may be calculated.

At a block 306, a first threshold and a second threshold are set. In this example, the first threshold is set to 90%, and the second threshold is set to 50%. Then, it is checked whether the usage rate of the IOPS upper limit of each storage volume meets a condition for reallocation. Assuming that at this moment, the usage rate of the IOPS upper limit of the storage volume A is 95%, which exceeds the first threshold; and the usage rate of the IOPS upper limit of the storage volume C is 45%, which is lower than the second threshold. At a block 308, the QoS upper limit is reallocated. In this example, a preset lending upper limit of the storage volume C is set to 10% of its IOPS upper limit, that is, 200. Therefore, the IOPS upper limit of the storage volume C is reduced by 200 and updated to 1800. At the same time, the IOPS upper limit of the storage volume A is increased by 200 and updated to 1200.

Through this process, the QoS upper limit of the storage volume set is dynamically adjusted according to the actual usage of the storage volumes, thereby optimizing the utilization of storage resources. It should be noted that during this process, it is necessary to ensure that when the QoS upper limit is reallocated, the QoS upper limit of any storage volume will not be lower than the minimum value required for its operation.

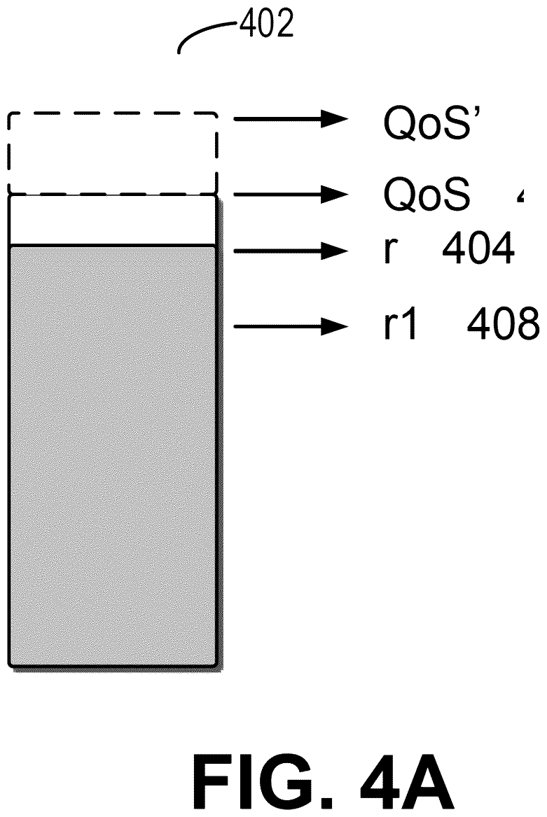

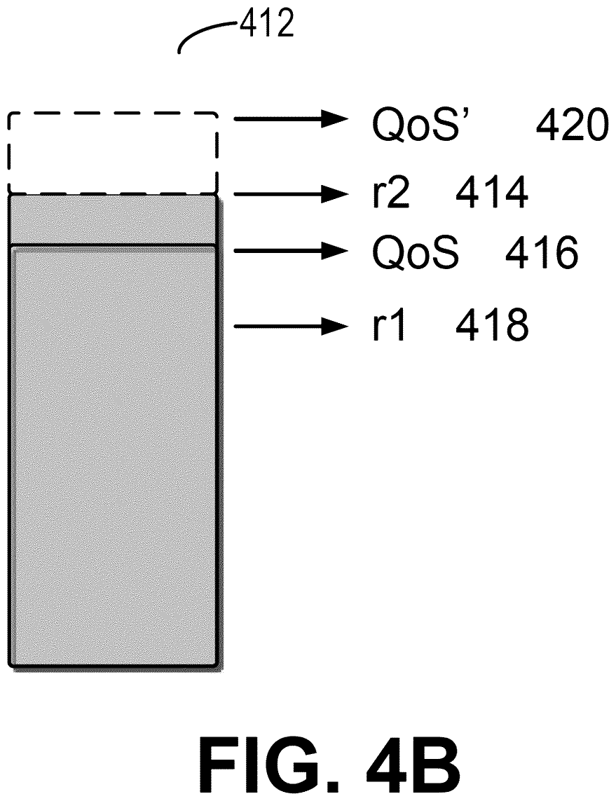

FIG. 4A is a diagram of the change process of a first storage volume according to an embodiment of the present disclosure. In this embodiment, the usage rate of the first storage volume 402 is represented by r 404, which may be calculated according to the formula (1), wherein r 404<QoS 406 and r 404>the first threshold r1 408, and the QoS 406 represents an old QoS upper limit of the first storage volume 402. After reallocation is performed according to the above embodiments, the QoS upper limit of the first storage volume 402 can be increased to QoS′ 410, and the QoS′ 410 represents a new QoS upper limit of the first storage volume 402.

FIG. 4B is a diagram of the change process of another first storage volume according to an embodiment of the present disclosure. In this embodiment, the usage rate of a first storage volume 412 is represented by r2 414, which may be calculated according to the formula (1), wherein r2 414>first threshold r3 418, and due to burst setting, r2 414>QoS 416, and the QoS 416 represents an old QoS upper limit of the first storage volume 412. After reallocation is performed according to the above embodiments, the QoS upper limit of the first storage volume 412 can be increased to QoS′ 420, and the QoS′ 420 represents a new QoS upper limit of the first storage volume 412. In the embodiments of FIG. 4A to FIG. 4B, the size of the QoS upper limit for reallocation may be determined according to the following formula (4).

$$Δ Q o S = \{ \begin{matrix}{r}_{borrow} \times QoS & If r \leq 1 \\ min ( {r}_{borrow} \times QoS , ( r - 1 ) \times QoS ) & If r > 1\end{matrix} \qquad Formula ( 4 )$$

wherein r_{borrow} represents the proportion of the borrowing upper limit, QoS represents the old QoS upper limit of the first storage volume, r represents the usage rate of the QoS upper limit of the first storage volume, min( ) is the minimum value function, and ΔQOS represents the borrowed QoS upper limit. When r>1, it means that the first storage volume may temporarily improve its performance beyond the QoS upper limit due to the burst setting. In this case, the smaller one of the borrowing upper limit and the burst amount is used as the borrowed QoS upper limit, thereby saving the QoS upper limit available for reallocation.

The present disclosure further provides some more comprehensive embodiments to better adjust the QoS of the storage volume set. When the QoS upper limit is reallocated at the block 206, the following operations are included. In response to that the usage rate of the QoS upper limit of the first storage volume is greater than the first threshold, a first subset requires to be first determined according to the storage volume set and the usage rate of the QoS upper limit of each storage volume. The characteristic of each storage volume in the first subset is that the usage rate of the QoS upper limit is lower than the second threshold. This actually adds a filtering process to narrow down the range of storage volumes that may lend out the QoS upper limits.

A storage volume that has a usage rate of the QoS upper limit being lower than a third threshold is selected from the first subset to serve as the second storage volume. A new threshold, the third threshold, is introduced here, which further limits the condition of the selectable lending QoS upper limit, thereby ensuring that only storage volumes with relatively low usage rates of the QoS upper limits (that is, having relatively idle performance) may be selected as lenders (that is, the second storage volume). Afterwards, a part of QoS upper limit from the QoS upper limit of the selected second storage volume is reallocated to the first storage volume.

The embodiment adds the conditions for filtering the second storage volume, so that the process of reallocating the QoS is more precise and flexible, which can better adapt to the actual usage of different storage volumes in the storage volume set. This design helps improve the utilization efficiency of storage resources and the overall performance of the system.

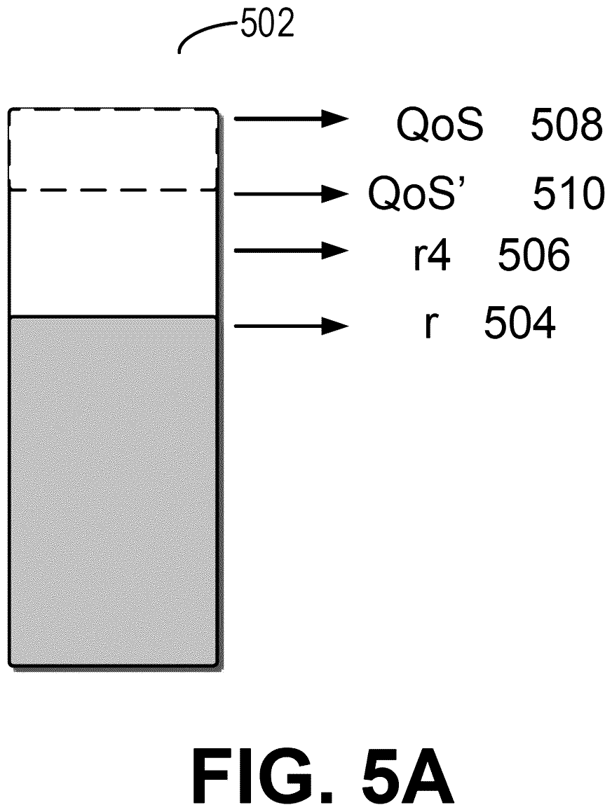

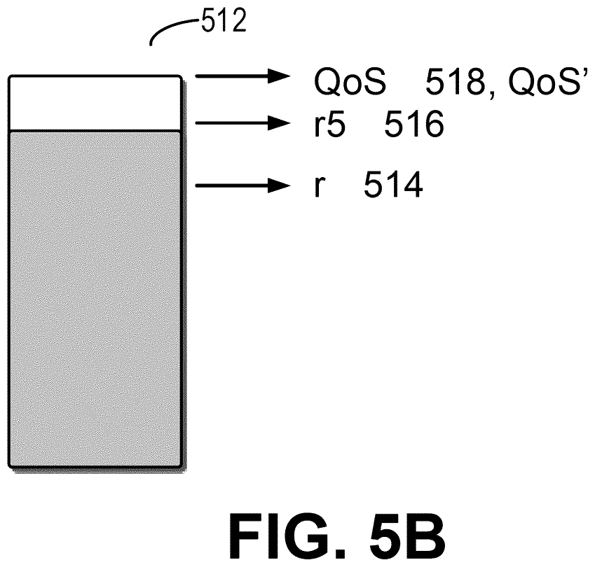

FIG. 5A is a schematic diagram of performing adjustment according to a third threshold according to an embodiment of the present disclosure. As shown in FIG. 5A, a usage rate r 504 of the QoS upper limit of a storage volume 502 is less than a third threshold r 4 506. The storage volume 502 may be used as the second storage volume, a part of its QoS upper limit may be reallocated to another storage volume, and its updated QoS upper limit QoS' 510 is less than a predetermined QoS upper limit QoS 508.

FIG. 5B is a schematic diagram of performing adjustment according to a third threshold according to another embodiment of the present disclosure. As shown in FIG. 5B, if a usage rate r 514 of the QoS upper limit of a storage volume 512 is greater than a third threshold r5 516, the storage volume 512 should not be used as the second storage volume, and its updated QoS upper limit QoS' 520 is equal to a predetermined QoS upper limit QoS 518.

In some embodiments, the operation of selecting a storage volume with a usage rate of the QoS upper limit being lower than the third threshold from the first subset to serve as the second storage volume is implemented as follows. First, the storage volumes in the first subset are sorted. Specifically, it requires determining an ordinal number of each storage volume in ascending order according to usage rates of QoS upper limits. This sorting process is actually a priority sorting, where a storage volume with a low usage rate (that is, the storage volume with a lighter load) may be assigned a lower ordinal number, thus having a higher priority in a subsequent selecting process.

Next, the second storage volume is determined based on at least the ordinal number of each storage volume in the first subset and the third threshold. The term “at least” here means that other factors (such as the type, performance, capacity, and the like of the storage volume may be considered), but ordinal numbers and the third threshold are key factors that must be considered. The ordinal numbers play a filtering and sorting role here, while the third threshold sets a minimum usage rate limit, and only storage volumes with usage rates below this threshold may be considered as the second storage volume.

Although the second threshold has defined the range of storage volumes that may be lent out, there is a problem in practice: a storage volume has a usage rate below the second threshold for a period of time and is selected as the second storage volume, and a part of the QoS upper limit is reallocated to the first storage volume. However, not long after, the second storage volume becomes busier, so that the usage rate of the second storage volume easily exceeds the first threshold, triggering the execution of the method of the present disclosure of lending the QoS upper limit from another storage volume (such as a third storage volume) and reallocating it to the second storage volume. This type of repeated borrowing is referred to as “borrowing fragment,” which significantly increases the system burden.

In the embodiment, when the second storage volume is selected, not only the current load situation (that is, the usage rate) of the storage volume is considered, but clear filtering conditions are also set through ordinal numbers and thresholds. This design helps reallocate the QoS upper limit of the storage volume with a very low usage rate, thereby avoiding ineffective allocation for the storage volume with a not too low usage rate. This design is not only beneficial for optimizing the utilization of storage resources, but also improves the stability and performance of the system.

When the usage rate of the QoS upper limit of the first storage volume not only exceeds the first threshold, but also exceeds the predetermined QoS upper limit, in order to reduce the “borrowing fragment,” it is no longer necessary to complete a borrowing based on the borrowing upper limit. Instead, the magnitude of the borrowed QoS upper limit is determined according to a difference between the current QoS upper limit in the first storage volume and the predetermined QoS upper limit. In this way, the requirement of the first storage volume can be met through a single borrowing, thereby reducing the “borrowing fragment” and reducing the system burden.

In some embodiments, the operation of reallocating according to the ordinal numbers and the third threshold includes acquiring the number of lending of each storage volume in the first subset. The number of lending refers to the number of times the storage volume, serving as the second storage volume, lends its QoS upper limit to others. The operation further includes determining, for each storage volume in the first subset, a weighted sum of the number of lending of the storage volume and the ordinal number to serve as a lending evaluation for the storage volume. As an example, weighting coefficients for the number of lending and the ordinal number may be 0.5 and 0.5, respectively. The operation further includes using the storage volume with the lowest lending evaluation in the first subset as the second storage volume.

Usually, a smaller ordinal number represents a lower usage rate of the storage volume and a higher rank in the sequence, that is, a higher priority. The fewer times the lending is made, the higher the QoS upper limit retained by the storage volume. By weighting the two index values to determine the lending evaluation, the second storage volume may be more reasonably determined. Similarly, in some embodiments, the first storage volume has a preset number of borrowing, a first number of times the first storage volume borrows the QoS upper limit is determined, and in response to the first number of times being greater than the preset number of borrowing, the QoS upper limit of the first storage volume maintains unchanged. That is, the allocation of QoS upper limits is balanced from the perspective of the borrower (the first storage volume).

In some embodiments, all storage volumes with usage rates greater than the first threshold are sorted in descending order, so that the storage volume with the highest usage rate has the highest priority. Then, based on the priority order, the QoS upper limit is borrowed for each first storage volume. This can ensure that the busiest storage volume receives assistance first, so that the overall service of the storage volume set is stable.

In some embodiments, the behavior of the second storage volume in the process of QoS reallocation is more scientifically regulated through a newly set index, a preset lending bottom limit. In this embodiment, the second storage volume has a preset lending bottom limit. This bottom limit is actually a minimum limit on the QoS upper limit that the second storage volume can lend out, ensuring that in the QoS reallocation process, the QoS of the second storage volume may not be severely affected by excessive lending, thereby protecting the normal operation of the serving application or business.

After the reallocation is completed, an updated QoS upper limit of the second storage volume is determined. This updated QoS upper limit is the remaining QoS upper limit of the second storage volume after the QoS is reallocated. By comparing the updated QoS upper limit with the predetermined QoS upper limit, a lending proportion may be calculated, which is a ratio of the actual lent QoS upper limit of the second storage volume to its original QoS upper limit.

If the lending proportion is greater than the preset lending bottom limit, the second storage volume needs to be deleted from the first subset. This step is actually a protection mechanism for the second storage volume. When the QoS upper limit lent out by the second storage volume exceeds its preset bottom limit, it will be removed from the lendable storage volume set to avoid further QoS loss. The embodiment ensures the fairness and sustainability of the process of reallocating the QoS upper limit. It not only considers the requirement of the first storage volume, but also fully considers the capability and limitation of the second storage volume, thereby avoiding unnecessary damage to either party.

Similarly, in some embodiments, a newly set index, that is, a preset borrowing upper limit is introduced for restriction. In the embodiment, the first storage volume has a preset borrowing upper limit. After reallocation, the total amount of QoS upper limit borrowed by the first storage volume is determined. A borrowing proportion of the QoS upper limit borrowed by the first storage volume is determined according to the total amount of QoS upper limit and the predetermined QoS upper limit. In response to the borrowing proportion exceeding the borrowing upper limit, the QoS upper limit of the first storage volume is kept unchanged. In the embodiment, the fairness and sustainability of the process of reallocating the QoS upper limit are ensured by limiting the borrower (the first storage volume).

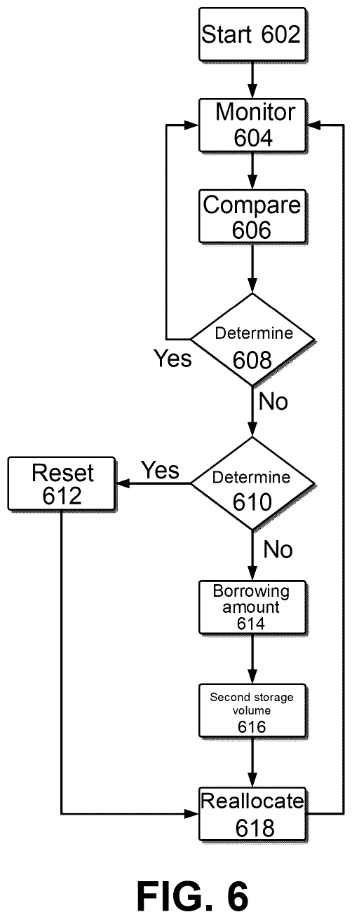

FIG. 6 is a schematic diagram of adjusting the QoS of a storage volume set according to an embodiment of the present disclosure. It starts at 602. Firstly, at 604, a storage volume management system may monitor the performance, such as IOPS or bandwidth, of various storage volumes according to a preset cycle. At 606, a usage rate of a QoS upper limit allocated to a corresponding storage volume is determined according to each performance, such as comparing a predetermined QoS upper limit with the monitored IOPS or bandwidth. At 608, it is determined whether the usage rates of all storage volumes are less than a first threshold. If so, the procedure goes back to 604. If not, the procedure proceeds to 610 and continues to determine whether the usage rates of all storage volumes are greater than the first threshold. If so, the procedure proceeds to 612 and resets the QoS upper limits of all storage volumes to the predetermined QoS upper limit. If not, the procedure proceeds to 614 and determines the amount of the QoS upper limit that needs to be borrowed. At 616, a second storage volume is selected from a first subset, where the usage rate of the QoS upper limit of the second storage volume is less than a second threshold. At 618, a part of QoS upper limit in the QoS upper limit allocated to the second storage volume is reallocated to the first storage volume. Then, the procedure returns to 604 to prepare for a new round of the process.

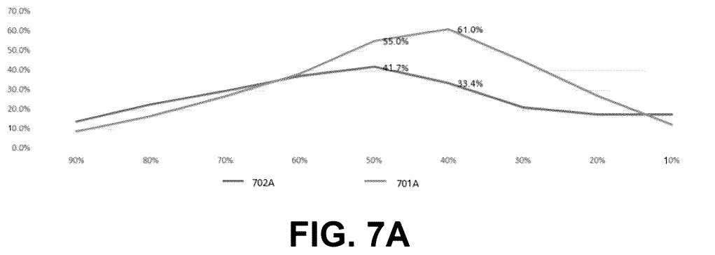

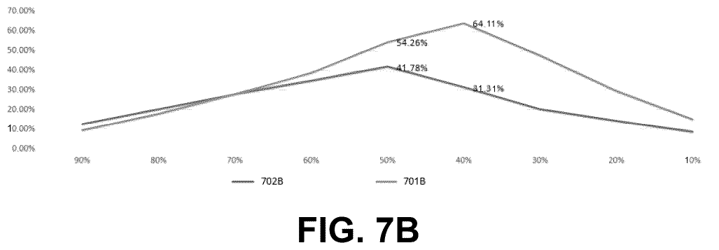

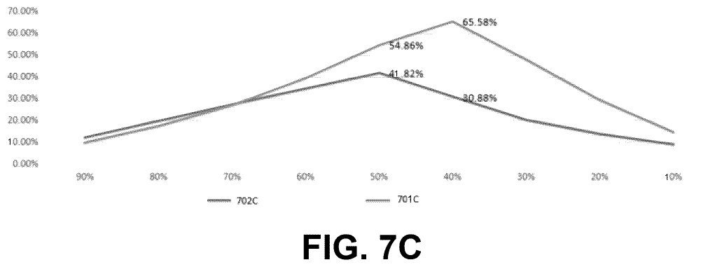

FIG. 7A to FIG. 7C are schematic effect diagrams of a method for adjusting the QoS of a storage volume set according to an embodiment of the present disclosure. The storage volume set in FIG. 7A includes 20 storage volumes, the storage volume set in FIG. 7B includes 100 storage volumes, and the storage volume set in FIG. 7C includes 1000 storage volumes. In FIG. 7A to FIG. 7C, both the horizontal and vertical axes represent percentage sizes. Curves 701A to 701C represent average performance improvement percentages of the storage volumes, and curves 702A to 702C represent percentages of storage volumes that have been used to reallocate QoS upper limits. Larger values in the curves 701A to 701C indicate more improvements of the QoS of the storage volume set. Smaller values of the curve 702A to 702C indicate fewer storage volumes that have been used to reallocate the QoS upper limits, and less burden it brings to the system. As can be seen from FIG. 7A to FIG. 7C, in a range of 10% to 40% on the horizontal axis, the embodiments of the present disclosure can significantly improve the QoS of the storage volume set with less burden.

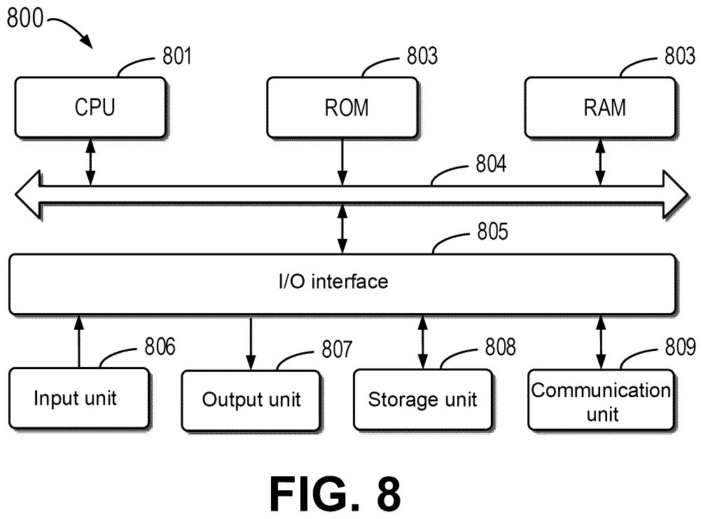

FIG. 8 shows a schematic block diagram of an example device 800 that can be used to implement an embodiment of the present disclosure. As shown in the figure, the device 800 includes a computing unit 801, which may execute various appropriate actions and processing according to computer program instructions stored in a read-only memory (ROM) 802 or computer program instructions loaded from a storage unit 808 onto a random access memory (RAM) 803. Various programs and data required for the operation of the device 800 may also be stored in the RAM 803. The computing unit 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, such as a keyboard and a mouse; an output unit 807, such as various types of displays and speakers; the storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The computing unit 801 may be various general-purpose and/or special-purpose processing components with processing and computing capabilities. Some examples of the computing unit 801 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 801 performs various methods and processes described above, such as the method 200. For example, in some embodiments, the method 200 may be implemented as a computer software program that is tangibly included in a machine-readable medium, such as the storage unit 808. In some embodiments, part or all of the computer program may be loaded and/or installed onto the device 800 via the ROM 802 and/or the communication unit 809. When the computer program is loaded to the RAM 803 and executed by the computing unit 801, one or more steps of the method 200 described above may be performed. Alternatively, in other embodiments, the computing unit 801 may be configured to implement the method 200 in any other suitable manners (such as by means of firmware).

The functions described hereinabove may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program codes for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method for adjusting the quality of service (QoS) of a storage volume set, wherein the storage volume set comprises at least two storage volumes, each storage volume is allocated a predetermined QoS upper limit, and the method comprises:
acquiring the performance of each storage volume in the storage volume set;
determining a usage rate of the QoS upper limit allocated to a corresponding storage volume according to each performance; and
reallocating, in response to the usage rate of the QoS upper limit allocated to a first storage volume in the storage volume set being greater than a first threshold and the usage rate of the QoS upper limit allocated to a second storage volume in the storage volume set being less than a second threshold, a part of QoS upper limit in the QoS upper limit allocated to the second storage volume to the first storage volume.

2. The method according to claim 1, wherein the second storage volume has a preset lending upper limit, and the reallocating a part of QoS upper limit in the QoS upper limit allocated to the second storage volume to the first storage volume comprises:
reducing the QoS upper limit allocated to the second storage volume by the preset lending upper limit to obtain an updated QoS upper limit allocated to the second storage volume; and
increasing the QoS upper limit allocated to the first storage volume by the preset lending upper limit.

3. The method according to claim 1, wherein the reallocating, in response to the usage rate of the QoS upper limit allocated to a first storage volume in the storage volume set being greater than a first threshold and the usage rate of the QoS upper limit allocated to a second storage volume in the storage volume set being less than a second threshold, a part of QoS upper limit in the QoS upper limit allocated to the second storage volume to the first storage volume comprises:
determining, in response to the usage rate of the QoS upper limit allocated to the first storage volume in the storage volume set being greater than the first threshold, a first subset according to the storage volume set and the usage rate of the QoS upper limit of each storage volume, wherein the usage rate of the QoS upper limit of each storage volume in the first subset is less than the second threshold;
selecting a storage volume having the usage rate of the QoS upper limit being less than a third threshold from the first subset to serve as the second storage volume; and
reallocating a part of QoS upper limit in the QoS upper limit allocated to the second storage volume to the first storage volume.

4. The method according to claim 3, wherein the selecting a storage volume having the usage rate of the QoS upper limit being less than a third threshold from the first subset to serve as the second storage volume comprises:
determining an ordinal number of each storage volume in the first subset in ascending order of usage rates; and
determining the second storage volume from the first subset at least according to the ordinal number of each storage volume in the first subset and the third threshold.

5. The method according to claim 4, wherein the second storage volume has a preset number of lending, and the determining the second storage volume from the first subset at least according to the ordinal number of each storage volume in the first subset and the third threshold comprises:
acquiring the number of lending of each storage volume in the first subset;
determining, for each storage volume in the first subset, a weighted sum of the number of lending of the storage volume and the ordinal number to serve as a lending evaluation for the storage volume; and
using the storage volume with the lowest lending evaluation in the first subset as the second storage volume.

6. The method according to claim 4, wherein the second storage volume has a preset lending bottom limit, and the method further comprises:
determining an updated QoS upper limit of the second storage volume;
determining a lending proportion according to the updated QoS upper limit and the predetermined QoS upper limit; and
deleting the second storage volume from the first subset in response to the lending proportion being greater than the preset lending bottom limit.

7. The method according to claim 1, wherein the first storage volume has a preset number of borrowing, and the method further comprises:
determining a first number of times the first storage volume borrows the QoS upper limit; and
keeping, in response to the first number of times being greater than the preset number of borrowing, the QoS upper limit of the first storage volume unchanged.

8. The method according to claim 1, wherein the first storage volume has a preset borrowing upper limit, and the method further comprises:
determining a total amount of the QoS upper limit borrowed by the first storage volume;
determining, according to the total amount of the QoS upper limit and the predetermined QoS upper limit, a borrowing proportion of the QoS upper limit borrowed by the first storage volume; and
keeping, in response to the borrowing proportion being greater than the borrowing upper limit, the QoS upper limit of the first storage volume unchanged.

9. The method according to claim 1, wherein the performance comprises at least one of input/output operations per second and bandwidth.

10. The method according to claim 1, wherein the second storage volume has a preset borrowing upper limit, and the reallocating a part of QoS upper limit in the QoS upper limit allocated to the second storage volume to the first storage volume comprises:
reducing the QoS upper limit allocated to the second storage volume by the preset borrowing upper limit to obtain an updated QoS upper limit allocated to the second storage volume; and
increasing the QoS upper limit allocated to the first storage volume by the preset borrowing upper limit.

11. An electronic device for adjusting the quality of service (QoS) of a storage volume set, wherein the storage volume set comprises at least two storage volumes, each storage volume is allocated a predetermined QoS upper limit, and the electronic device comprises:
at least one processor; and
a memory coupled to the at least one processor and having instructions stored thereon, wherein the instructions, when executed by the at least one processor, cause the electronic device to perform actions comprising:
acquiring the performance of each storage volume in the storage volume set;
determining a usage rate of the QoS upper limit allocated to a corresponding storage volume according to each performance; and
reallocating, in response to the usage rate of the QoS upper limit allocated to a first storage volume in the storage volume set being greater than a first threshold and the usage rate of the QoS upper limit allocated to a second storage volume in the storage volume set being less than a second threshold, a part of QoS upper limit in the QoS upper limit allocated to the second storage volume to the first storage volume.

12. The electronic device according to claim 11, wherein the second storage volume has a preset lending upper limit, and the reallocating a part of QoS upper limit in the QoS upper limit allocated to the second storage volume to the first storage volume comprises:
reducing the QoS upper limit allocated to the second storage volume by the preset lending upper limit to obtain an updated QoS upper limit allocated to the second storage volume; and
increasing the QoS upper limit allocated to the first storage volume by the preset lending upper limit.

13. The electronic device according to claim 11, wherein the reallocating, in response to the usage rate of the QoS upper limit allocated to a first storage volume in the storage volume set being greater than a first threshold and the usage rate of the QoS upper limit allocated to a second storage volume in the storage volume set being less than a second threshold, a part of QoS upper limit in the QoS upper limit allocated to the second storage volume to the first storage volume comprises:
determining, in response to the usage rate of the QoS upper limit allocated to the first storage volume in the storage volume set being greater than the first threshold, a first subset according to the storage volume set and the usage rate of the QoS upper limit of each storage volume, wherein the usage rate of the QoS upper limit of each storage volume in the first subset is less than the second threshold;
selecting a storage volume having the usage rate of the QoS upper limit being less than a third threshold from the first subset to serve as the second storage volume; and
reallocating a part of QoS upper limit in the QoS upper limit allocated to the second storage volume to the first storage volume.

14. The electronic device according to claim 13, wherein the selecting a storage volume having the usage rate of the QoS upper limit being less than a third threshold from the first subset to serve as the second storage volume comprises:
determining an ordinal number of each storage volume in the first subset in ascending order of usage rates; and
determining the second storage volume from the first subset at least according to the ordinal number of each storage volume in the first subset and the third threshold.

15. The electronic device according to claim 14, wherein the second storage volume has a preset number of lending, and the determining the second storage volume from the first subset at least according to the ordinal number of each storage volume in the first subset and the third threshold comprises:
acquiring the number of lending of each storage volume in the first subset;
determining, for each storage volume in the first subset, a weighted sum of the number of lending of the storage volume and the ordinal number to serve as a lending evaluation for the storage volume; and
using the storage volume with the lowest lending evaluation in the first subset as the second storage volume.

16. The electronic device according to claim 14, wherein the second storage volume has a preset lending bottom limit, and the method further comprises:
determining an updated QoS upper limit of the second storage volume;
determining a lending proportion according to the updated QoS upper limit and the predetermined QoS upper limit; and
deleting the second storage volume from the first subset in response to the lending proportion being greater than the preset lending bottom limit.

17. The electronic device according to claim 11, wherein the first storage volume has a preset number of borrowing, and the actions further comprise:
determining a first number of times the first storage volume borrows the QoS upper limit; and
keeping, in response to the first number of times being greater than the preset number of borrowing, the QoS upper limit of the first storage volume unchanged.

18. The electronic device according to claim 11, wherein the first storage volume has a preset borrowing upper limit, and the actions further comprise:
determining a total amount of the QoS upper limit borrowed by the first storage volume;
determining, according to the total amount of the QoS upper limit and the predetermined QoS upper limit, a borrowing proportion of the QoS upper limit borrowed by the first storage volume; and
keeping, in response to the borrowing proportion being greater than the borrowing upper limit, the QoS upper limit of the first storage volume unchanged.

19. The electronic device according to claim 11, wherein the performance comprises at least one of input/output operations per second and bandwidth.

20. A computer program product having a non-transitory computer readable medium which stores a set of instructions to adjust the quality of service (QoS) of a storage volume set, wherein the storage volume set comprises at least two storage volumes, each storage volume is allocated a predetermined QoS upper limit; the set of instructions, when carried out by computerized circuitry, causing the computerized circuitry to perform a method of:
acquiring the performance of each storage volume in the storage volume set;
determining a usage rate of the QoS upper limit allocated to a corresponding storage volume according to each performance; and
reallocating, in response to the usage rate of the QoS upper limit allocated to a first storage volume in the storage volume set being greater than a first threshold and the usage rate of the QoS upper limit allocated to a second storage volume in the storage volume set being less than a second threshold, a part of QoS upper limit in the QoS upper limit allocated to the second storage volume to the first storage volume.
